(19) United States
(12) Patent Application Publication
(10) Pub. No.: US 2005/0071761 A1
(43) Pub. Date: Mar. 31, 2005

(54) User interface on a portable electronic device

(75) Inventor: Pertti Kontio, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/671,003

(22) Filed: Sep. 25, 2003

(51) Int. Cl. G06F 3/00

(52) U.S. Cl. 715/711; 715/814; 715/813; 715/812; 715/810; 715/709; 715/715; 715/705; 715/708; 715/859

(57) ABSTRACT

An electronic device capable of carrying out a plurality of commands, which are symbolized by a plurality of icons displayed on a touch screen so as to allow a user to select a command by contacting the screen at the icon with a pen, or other object. If the contact is brief, the selected command is carried out. If the contact is longer than a predetermined time, a message associated with the command is provided. In the latter case, if the user still wants the selected command to be carried out, the user removes the pen off the screen directly from the icon. Otherwise, the user moves the pen out of the icon area. The message is then ended. If the user moves the pen to another icon, a different message is provided. The message can be provided in a text form or an audible form.

### FIELD OF THE INVENTION

The present invention relates to a portable electronic device having a touch screen to allow a user to use an object to interact with the touch screen

### BACKGROUND OF THE INVENTION

A portable electronic device, such as a Communicator, a Personal Digital Assistant (PDA), some cell phones and the like, usually has a touch screen for displaying data, messages and/or images. The touch screen can also be used to allow a user to input signals and data in the portable electronic device using a stylus, commonly referred to as a pen. Using such as pen to touch one of the designated areas on the screen, the user can cause the portable device to carry out a certain function. Usually, the designated areas are displayed as buttons or icons. For example, the buttons or icons can be depicted as a telephone handset, an envelope, a keyboard, etc. If the user uses a pen to touch the icon depicting a telephone handset, a menu or a list of items related to telephone calls is displayed on the touch screen so as to allow the user to select one of the displayed items to specify the next task. The user may want to read the telephone numbers of the latest outgoing calls, incoming calls and the like. Similarly, “links” or “hot spots” are also displayed on a Web page to allow a user to click on in order to review another spot in the Web page or to access another document. For example, a picture may be used as a link.

As more and more functions are built into a portable electronic device, more buttons are needed to be shown on part of the touch screen so as to allow a user to activate those functions. The user may not be able to determine the function or command related to each button. Especially when the touch screen is small, there is not enough display area to depict an icon with a meaningful shape, or to attach an easily understandable legend to a button.

Thus, it is desirable and advantageous to provide a method of explaining the functions of the buttons on a pen-based touch screen.

### SUMMARY OF THE INVENTION

The present invention allows a user to interact with an icon displayed on a display screen of a pen-based electronic device in different fashions. The user can contact the icon in order to select a function or command associated with the icon, or to obtain a message associated with the function or command. The message can be provided in a text form or an audible form.

Thus, according to the first aspect of the present invention, there is provided a method of interacting with an icon displayed on a touch screen in an electronic device. The electronic device is capable of carrying a command symbolized by the icon and further capable of providing a message associated with the command, wherein the icon is displayed at a designated area of the screen so as to allow a user to interact with the icon by using a physical object. The method comprises the steps of:
1) contacting the screen at the designated area by the physical object; and
2) removing the physical object from the screen before a selected time has expired to cause the electronic device to carry out the command, or
3) keeping the physical object at the designated area longer than the selected time to cause the electronic device to provide the message.

Preferably, the method further comprises the step of:
4) removing the physical object from the screen after step 3 to cause the electronic device to carry out the command, or
5) moving the physical object off the designated area while keeping the physical object substantially on the screen after step 3 to end the message.

Preferably, the method further comprises the step of:
6) removing the physical object from the screen after step 5 to cause the command to be executed; or
7) moving the physical object to a further designated area after step 5 for causing the electronic device to provide a message associated with the further designated area.

The method further comprises the step of:
8) removing the physical object from the screen after step 7 to cause the command associated with the further designated area to be executed.

The message can be a text message, a graphical or animated message or an audible message or the combination thereof.

According to the second aspect of the present invention, there is provided an electronic device capable of carrying out a plurality of commands. The electronic device comprises:
a touch screen having a plurality of designated areas for displaying a plurality of icons symbolizing the commands, so as to allow a user to interact with an icon by using a physical object to contact the screen at the corresponding designated area;
a sensing device, operatively connected to the screen to sense the contact of the screen by the physical object, for providing a signal in the electronic device indicative of said contacting, and
means, responsive to the signal, for carrying out further steps, such that
if the physical object is removed from the screen after contacting said designated area but before a selected time has expired, said means carries out the command symbolized by said icon, and
if the physical object is kept at said designated area longer than the selected time, said means provides a message associated with said command.

Furthermore, if the physical object is removed from the screen after the physical object is kept at said designated area longer than the selected time and the message is provided, said means carries out the symbolized command, and
if the physical object is moved off said designated area after the message is provided while the physical object is kept substantially on the screen, said means ends the message.

Moreover, if the physical object is moved to a further designated area after the physical object is moved off said designated area, said means provides a further message associated with the further designated area.

According to the third aspect of the present invention, there is provided a software program having a plurality of computer codes for carrying out a series of specific operational steps by a data processing means in an electronic device having a screen, the electronic device capable of carrying out a plurality of commands. Said series comprises:
a code for generating a plurality of icons symbolizing the commands, the icons displayed at a plurality of designated areas on the screen so as to allow a user to interact with an icon by using a physical object to contact the screen at the corresponding designated area; and
a code, responsive to said user interaction, for
causing the electronic device to carry out the command symbolized by said icon, if the physical object is removed from the screen after contacting said designated area but before a selected time has expired, the electronic device is caused to carry out the command symbolized by said icon, and causing the electronic device to provide a message associated with said command, if the physical object is kept at said designated area longer than the selected time.

The series further comprises:
a code for causing the electronic device to carry out the symbolized command, if the physical object is removed from the screen after the physical object is kept at said designated area longer than the selected time and the message is provided, and causing the electronic device to end the message if the physical object is moved off said designated area after the help message is provided while the physical object is kept substantially on the screen.

The series further comprises:
a code for causing the electronic device to provide a further message associated with a further designated area if the physical object is moved to the further designated area after the physical object is moved off said designated area.

The present invention will become apparent upon reading the description taken in conjunction with FIGS. 1 to 6.

### BRIEF DESCRIPTION OF THE DRAWINGS

FIG. 1 is a schematic representation of a portable electronic device showing a pen interface on a touch screen.

FIG. 2 is a schematic representation showing a text bubble displayed on the touch screen responding to the pressing of a button by the pen.

FIG. 3 is a schematic representation showing the disappearing of the text bubble after the pen is lifted from the button.

FIG. 4a is a schematic representation illustrating the disappearing of the text bubble after the pen is laterally moved out of the button area.

FIG. 4b is a schematic representation illustrating a different text bubble displayed on the touch screen when the pen is moved into a different button area.

FIG. 5 is a schematic representation illustrating the interaction between the pen and the touch screen, resulting in a signal sent to a signal processor in the portable electronic device.

FIG. 6 is a flowchart showing an exemplary method for interacting with an icon to activate a function and/or to see a text message.

### BEST MODE FOR CARRYING OUT THE INVENTION

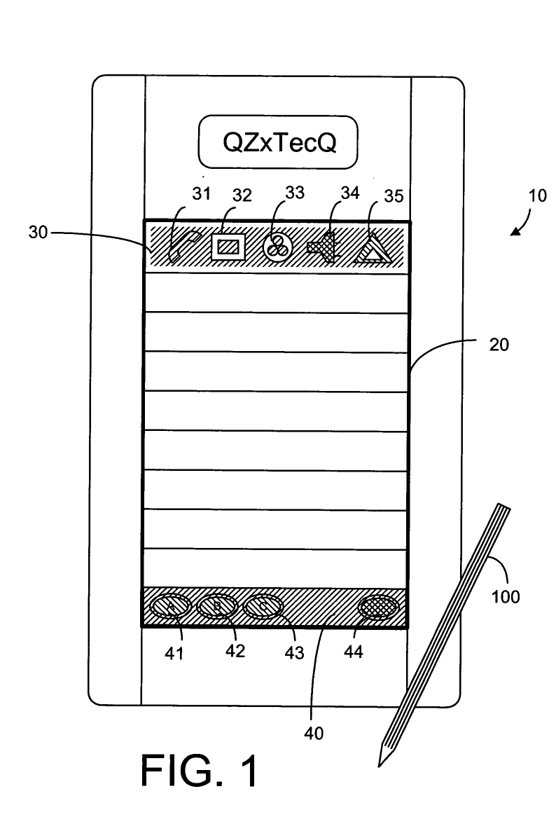

FIG. 1 illustrates a portable electronic device 10 having a touch screen 20, which can be used to display data, text or images. The touch screen 20 can also be used to show a user-interface (UI) to allow a user to input a signal in portable electronic device, causing the device to carry out a certain function or command. As shown, the UI has two sub-screen areas 20 and 30 for showing a plurality of icons or buttons 31-35 and 41-44, each of which is displayed at a designated area on the screen. A user can use a pen, a finger or any suitable physical object to touch or press one of the buttons to select a function or command. For example, if the user uses the pen 100 to select the icon 31, the user can access a list of telephone related functions. As more and more buttons are displayed to allow the user to choose among the many functions the portable device can carry out, the buttons may not be descriptive. It is difficult for a user to guess what those buttons do. It is useful to know what the buttons do before selecting them.

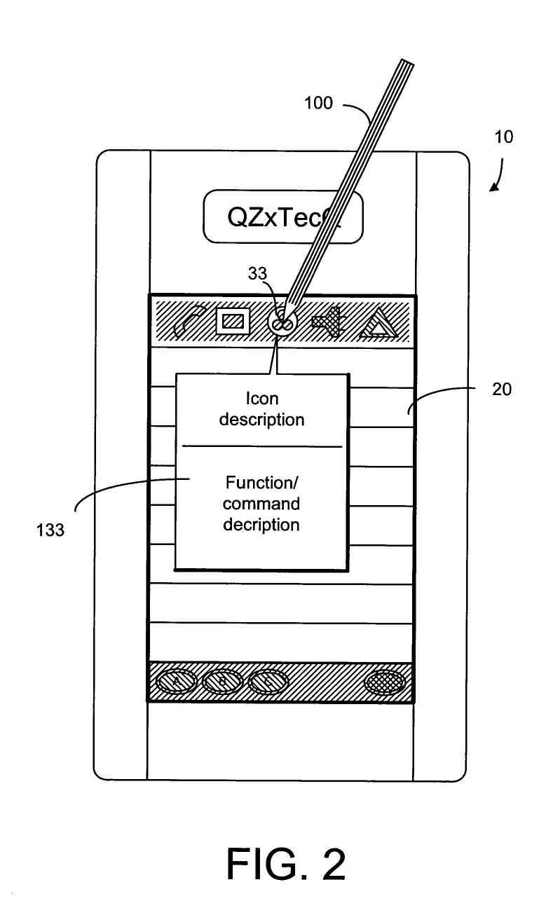

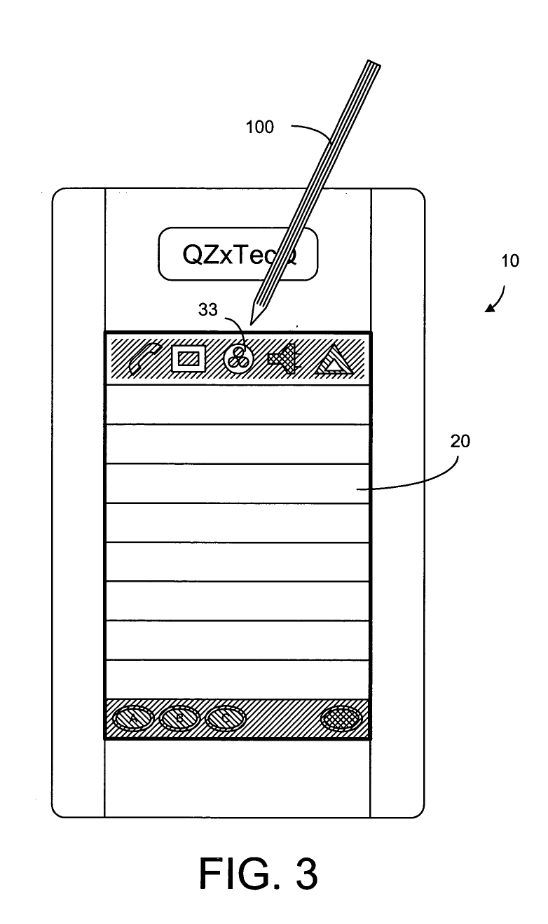

According to the present invention, the user can use to pen to interact with the touch screen in order to find out what function or command the portable device will carry out if a certain button is selected. To select a function or command, the user can briefly press, touch or click on the corresponding button. As such, the actual function or command is activated, but there is no text message on the screen. To find out what function is associated with the button, the user can press or touch the button for an extended time, say 0.5 sec without lifting the pen. As such, a pop-up text message or a text bubble appears on the screen until the user lifts the pen off the contacted area. A text bubble 133 is shown in FIG. 2. For example, the text bubble may contain the description of the button or icon, such as “image folder” if the button allows a user to access the images stored in the portable device 10. The text in the text bubble may provide information regarding the stored images, such as the number of images, the date received/stored, the sub-directories in the image folder, and so forth. The message in the text bubble may also be a URL, current time, today's date or other information. The text bubble disappears after the pen is lifted, as shown in FIG. 3. It should be noted that the term “to press” or “to touch” the screen, or “to click on” a button, as used in this specification means to use the pen to make physical contact with the screen, but it also means to place the pen within a predetermined distance from the screen in a non-contacting fashion.

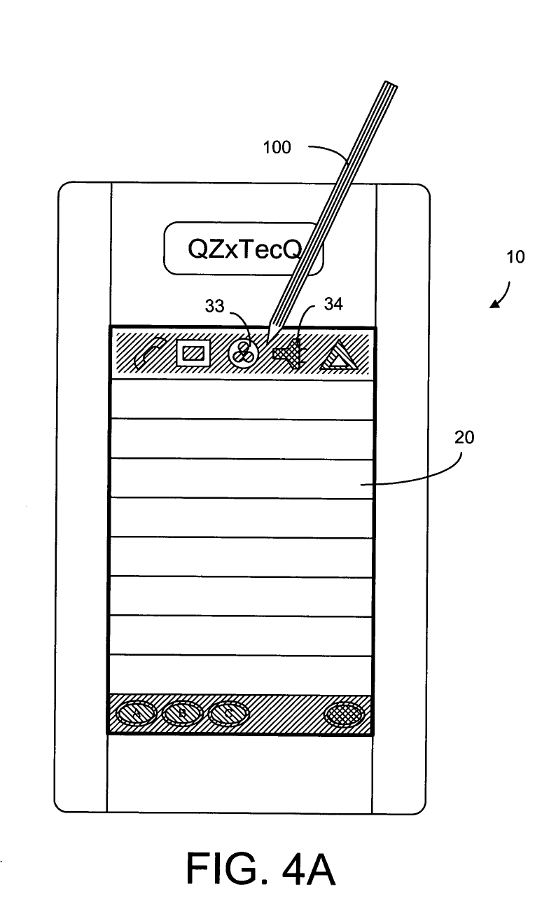

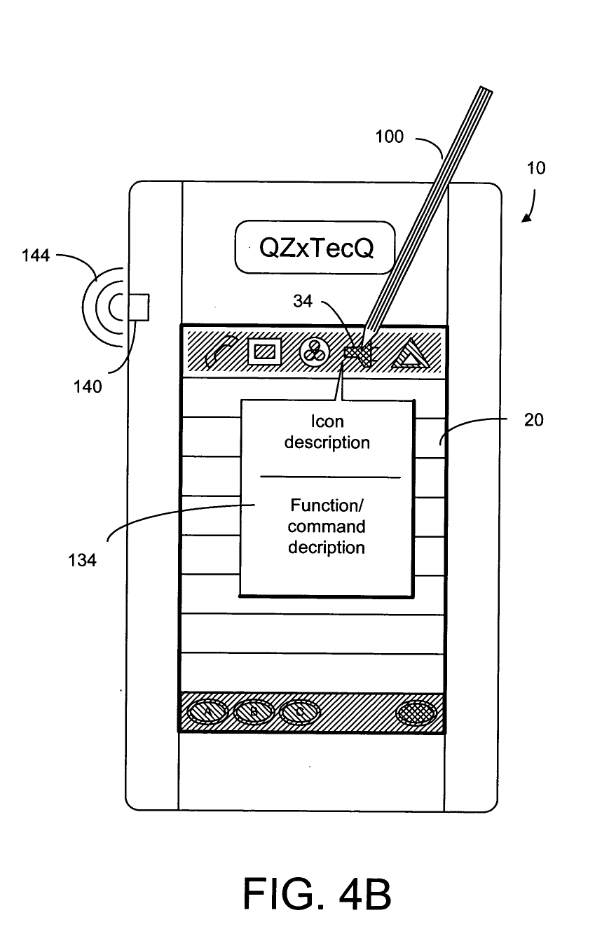

After the button area is pressed for an extended time and a text appears, the user has a choice to select or not select the associated function or command. If the user chooses to select the associated function or command, the user can lift the pen off the screen while the pen is on top of the button, as shown in FIG. 3. If the user chooses not to select the associated function or command, the user first moves the pen off the button area in a substantially lateral motion, as shown in the FIG. 4a, and then lifts the pen off the screen. This way, the user can choose whether he or she wants the command to be executed after he or she sees the text in text bubble.

If, prior to lifting the pen, the user moves the pen from one button to another, a new text bubble containing the text message associated with the other button appears, as shown in FIG. 4b. However, no command will be executed. The text bubble disappears when the pen is lifted off the screen. But the message can appear also in a designated message area on the screen or in any other suitable area.

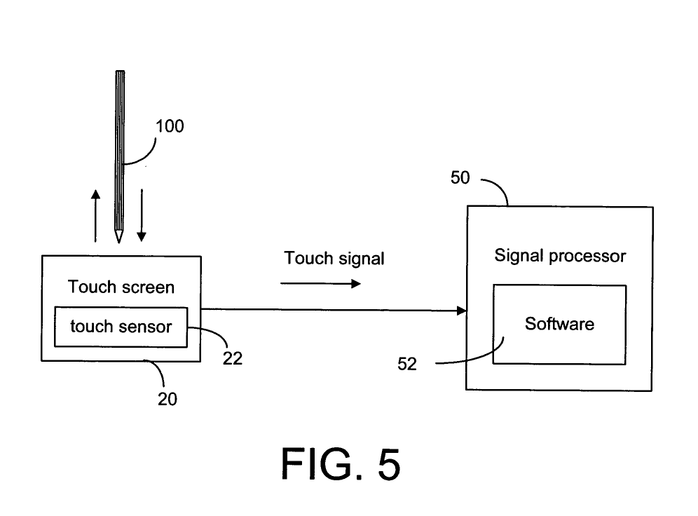

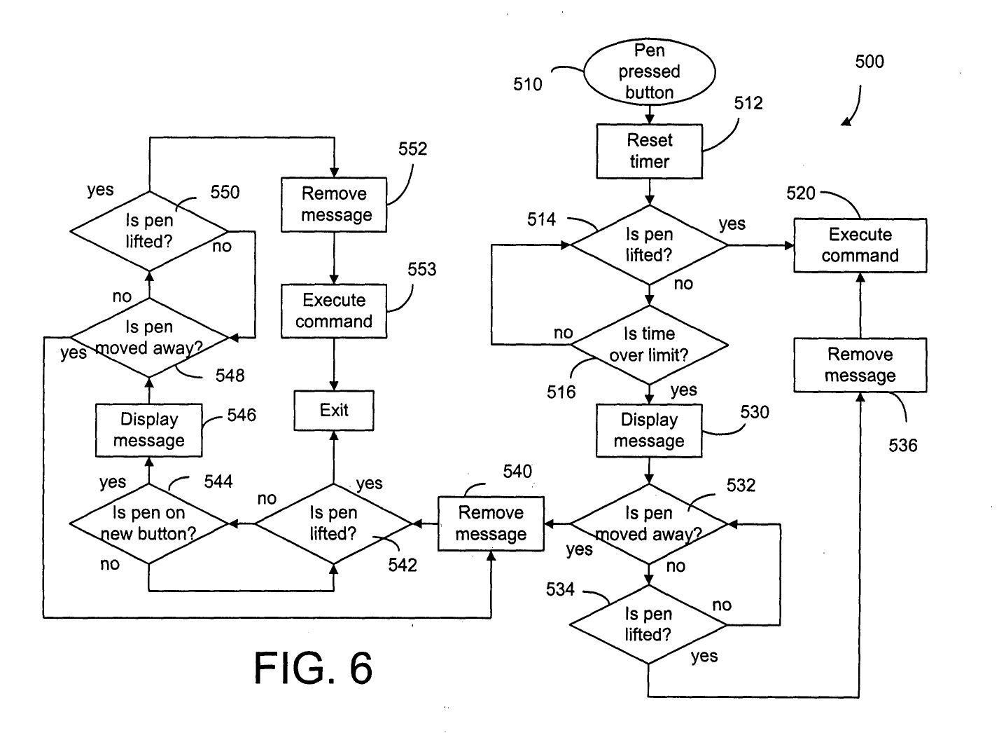

In order to carry out the present invention, the touch screen 20 has a sensing device 22, operatively connected to a signal processor 50 for sending a signal indicative of the screen being contacted by the pen 100. The signal processor 50 has a software program 52 for controlling the signal processor 50, as shown in FIG. 5. When a button on the touch screen is clicked by a pen, the software program 52 receives three messages: BUTTON_DOWN, BUTTON_PRESSED and BUTTON_UP, for example. The text message or text bubble is tied to the BUTTON_PRESSED message. The execution of command associated with the button is tied to the BUTTON_UP message. If the pen is first moved off the button area before it is lifted upward, the BUTTON_UP message will be received by the signal process or be ignored by the software program. If the pen is lifted off within a predetermined time after the button is pressed, the BUTTON_PRESSED message will be ignored. In that case, the user can select a command or function without seeing the text message. The method of using the pen-based user interface, according to the present invention, is illustrated in the flowchart 500 of FIG. 6. As shown, after the signal processor receives a signal indicative of the BUTTON-DOWN message from the touch screen that a button is clicked by a pen at step 510, a timer associated with the signal processor is reset at step 512. The signal processor keeps monitoring whether the pen is lifted at step 514 while checking the elapsed time. If the pen is lifted before a predetermined time limit, the signal processor responses to a signal indicative of the BUTTON_UP message and carries out the command associated with the button at step 520.

If the pen is pressed longer than a predetermined time limit, as determined at step 516, the signal processor responses to a signal indicative of the BUTTON_PRESSED message and causes a text bubble containing a text message associated with the button to appear on the touch screen at step 530. If the pen is lifted off the screen directly from the button at step 534, the text bubble disappears at step 536 and the related command is executed. However, if the pen is moved off the button area at step 532 before the pen is lifted, the text bubble disappears at step 540. If the pen is lifted at step 542, no command is executed. Furthermore, before the pen is lifted, if the pen is again moved onto a button (a new one or the original one) at step 544, a corresponding text message appears at step 546. At this stage, if the pen is lifted at step 550 directly from the button, the text disappear at step 552. A command related to this button is executed at step 553. It is also possible that no command is executed. If the pen is again moved away from the button at step 548 before the pen is lifted at step 550, the process step loops back to step 540 where the text message is removed from the screen.

The present invention has been described in conjunction with FIGS. 1 to 5. It should be appreciated by persons skilled in the art that these drawings are for illustration purposes only. The buttons or icons can be designed in many different ways and the text bubble can be designed to carry only a simple description of the command or function related to the button, but the text bubble can be designed to reveal a string of commands or sub-directory should the button be clicked. Furthermore, a message can be provided in other forms. For example, the message can be a text message, a graphical message or an animated message or the combination thereof. Furthermore, instead of displaying the message in the text bubble 133, 134 as shown in FIGS. 2 and 4b, the message can be provided in an audible form 144 through a speaker 140, as shown in FIG. 4b. The audible message can also be provided along with the visible message displayed on the screen. Preferably, the message disappears when the pen or physical object is moved out the icon area or is removed from the touch screen.

Moreover, if the pen or physical object is pressed on the touch screen at a place different from an icon area and then is moved into an icon area, it can be designed such that the message related to that icon is provided or not provided.

Thus, although the invention has been described with respect to a preferred embodiment thereof, it will be understood by those skilled in the art that the foregoing and various other changes, omissions and deviations in the form and detail thereof may be made without departing from the scope of this invention.

1. A method of interacting with an icon displayed on a touch screen in an electronic device, the electronic device capable of carrying a command symbolized by the icon and further capable of providing a message associated with the command, wherein the icon is displayed at a designated area of the screen so as to allow a user to interact with the icon by using a physical object, said method comprising the steps of:
1) contacting the screen at the designated area by the physical object; and
2) removing the physical object from the screen before a selected time has expired to cause the electronic device to carry out the command, or
3) keeping the physical object at the designated area longer than the selected time to cause the electronic device to provide the message.

2. The method of claim 1, further comprising the step of:
4) removing the physical object from the screen after step 3 to cause the electronic device to carry out the command, or
5) moving the physical object off the designated area while keeping the physical object substantially on the screen after step 3 to end the message.

3. The method of claim 2, further comprising the step of:
6) removing the physical object from the screen after step 5; or
7) moving the physical object to a further designated area after step 5 for causing the electronic device to provide a message associated with the further designated area.

4. The method of claim 3, further comprising the step of:
8) removing the physical object from the screen after step 7 to cause the electronic device to carry out a command associated with the further designated area.

5. The method of claim 1, wherein the provided message comprises a text message.

6. The method of claim 5, wherein the text message is displayed on the screen.

7. An electronic device capable of carrying out a plurality of commands, comprising:
a screen having a plurality of designated areas for displaying a plurality of icons symbolizing the commands, so as to allow a user to interact with an icon by using a physical object to contact the screen at the corresponding designated area;
a sensing device, operatively connected to the screen to sense the contact of the screen by the physical object, for providing a signal in the electronic device indicative of said contacting, and
means, responsive to the signal, for carrying out further steps, such that
if the physical object is removed from the screen after contacting said designated area but before a selected time has expired, said means carries out the command symbolized by said icon, and
if the physical object is kept at said designated area longer than the selected time, said means provides a message associated with said command.

8. The electronic device of claim 7, wherein
if the physical object is removed from the screen after the physical object is kept at said designated area longer than the selected time and the message is provided, said means carries out the symbolized command, and
if the physical object is moved off said designated area after the message is provided while the physical object is kept substantially on the screen, said means ends the message.

9. The electronic device of claim 8, wherein
if the physical object is moved to a further designated area after the physical object is moved off said designated area, said means provides a further message associated with the further designated area.

10. The electronic device of claim 9, wherein
when the physical object is removed from the screen after the physical object is moved to the further designated area, said means carries out a command associated with the further designated area.

11. The electronic device of claim 7, wherein the message is provided in a text bubble displayed on the screen.

12. The electronic device of claim 7, further comprising an audio device so that the message is provided in an audible form via the audio device.

13. A series of specific operational steps expressible in a plurality of computer codes to be executed by a data processing means in an electronic device having a screen, the electronic device capable of carrying out a plurality of commands, said series comprising:
a code for generating a plurality of icons symbolizing the commands, the icons displayed at a plurality of designated areas on the screen so as to allow a user to interact with an icon by using a physical object to contact the screen at the corresponding designated area; and
a code, responsive to said user interaction, for
causing the electronic device to carry out the command symbolized by said icon, if the physical object is removed from the screen after contacting said designated area but before a selected time has expired, the electronic device is caused to carry out the command symbolized by said icon, and
causing the electronic device to provide a message associated with said command, if the physical object is kept at said designated area longer than the selected time.

14. The series of claim 13, further comprising
a code for causing the electronic device to carry out the symbolized command, if the physical object is removed from the screen after the physical object is kept at said designated area longer than the selected time and the message is provided, and causing the electronic device to end the message if the physical object is moved off said designated area after the help message is provided while the physical object is kept substantially on the screen.

15. The series of claim 14, further comprising
a code for causing the electronic device to provide a further message associated with a further designated area if the physical object is moved to the further designated area after the physical object is moved off said designated area.
